(19) United States
(12) Patent Application Publication
(10) Pub. No.: US 2013/0138596 A1
(43) Pub. Date: May 30, 2013

(54) METHOD AND APPARATUS FOR AUTHORING TASK

(71) Applicant: Electronics and Telecommunications Research Institute, Daejeon (KR)

(72) Inventors: Rockwon KIM, Daejeon (KR); Seung-Ik LEE, Daejeon (KR); Sung Hoon KIM, Daejeon (KR)

(73) Assignee: Electronics and Telecommunications Research Institute, Daejeon (KR)

(21) Appl. No.: 13/655,789

(22) Filed: Oct. 19, 2012

(30) Foreign Application Priority Data
Nov. 24, 2011 (KR) 10-2011-0123461

(51) Int. Cl. G06N 5/02

(52) U.S. Cl. 706/47

(57) ABSTRACT

An apparatus for authoring a task includes a scenario extracted information input unit configured to receive data, an event, and behavior information that are extracted from a task scenario; and a partial behavior information generator configured to extract and write partial behavior rules/sequences based on the received data, event, and behavior information. Further, the apparatus includes an overall behavior information generator configured to set relationship between the written partial behavior rules/sequences and integrate the partial behavior rules/sequences according to the set relationship to write overall behavior rules/sequences; and a task conversion unit configured to convert the written overall behavior rules/sequences into a task which a robot and/or an intelligent agent may execute.

### CROSS-REFERENCE TO RELATED APPLICATIONS

The present invention claims priority of Korean Patent Application No. 10-2011-0123461, filed on Nov. 24, 2011, which is incorporated herein by reference.

### FIELD OF THE INVENTION

The present invention relates to a method and an apparatus for authoring a task; and more particularly, to the method and apparatus for authoring the task, which assist authoring of the task used in a robot and an intelligent agent.

### BACKGROUND OF THE INVENTION

In order to write a task performed by a robot or an intelligent agent, a task developer needs to know low level Application Programming Interface (API) usable by a robot and/or an intelligent agent in advance. The low level API is made by using a device drive such as a function of handling a sensor and a driver of a robot.

This developing method for authorizing a task from the low level to an upper level is called a bottom-up development method.

However, understanding of a programming language such as C/C++ are needed in order to use the low level API and this bottom-up development method makes writing of a task performed in a robot and/or an intelligent agent by a user who does not comprehend the low level API difficult.

There is an existing method for authoring the task using script language enabling to define a task without directly using the low level API.

However, the method for authoring the task using script language also has a drawback that a user should comprehend concept and syntax of the script language and semantics thereof the concept and syntax. This script language is basically characterized by syntax structure similar to a programming language.

Especially, in order to increase utilization of robots which are widely distributed, a user of the robot can easily load procedures and rules of the robot's behavior that the user desires in the robot.

In order to overcome the above-mentioned drawbacks, robot vendors provide graphic-based tools capable of easily authoring tasks to be loaded in the robots. These tools are also based on the bottom-up development and have drawback that a user must acquire knowledge on use of the tools in advance.

### SUMMARY OF THE INVENTION

In view of the above, the present invention provides a method and an apparatus for authoring a task, which assist authoring of the task used in robots and/or intelligent agents in top-down development.

In accordance with a first aspect of the present invention, there is provided an apparatus for authoring a task, including: a scenario extracted information input unit configured to receive data, an event, and behavior information that are extracted from a task scenario; a partial behavior information generator configured to extract and write partial behavior rules/sequences based on the received data, event, and behavior information; an overall behavior information generator configured to set relationship between the written partial behavior rules/sequences and integrate the partial behavior rules/sequences according to the set relationship to write overall behavior rules/sequences; and a task conversion unit configured to convert the written overall behavior rules/sequences into a task which a robot and/or an intelligent agent may execute.

The apparatus may further comprise an information input assist unit assisting to extract and input the data, the event, and the behavior information from the task scenario.

Further, the overall behavior information generator may convert the partial behavior rules/sequences using a preset conversion rule to write the overall behavior rules/sequences.

In accordance with a second aspect of the present invention, there is provided a method for authoring a task, which is performed by an apparatus for authoring a task. The method includes acquiring data, an event, and behavior information which are extracted from a task scenario; extracting and writing partial behavior rules/sequences based on the acquired data, event, and behavior information; integrating the partial behavior rules/sequences according to relationship between the written partial behavior rules/sequences to write overall behavior rules/sequences; and converting the written overall behavior rules/sequences into a task that a robot or an intelligent agent executes.

The method may further comprise assisting to extract and to input the data, the event, and the behavior information from the task scenario.

Further, said writing overall behavior rules/sequences may be performed such that the partial behavior rules/sequences are converted using a preset conversion rule to write the overall behavior rules/sequences.

In accordance with an embodiment of the present invention, top-down development is assisted to author the task used in robots and/or intelligent agents.

Thus, even a user who is not experienced with programming and/or specific script languages can easily author the task.

### BRIEF DESCRIPTION OF THE DRAWINGS

The objects and features of the present invention will become apparent from the following description of embodiments given in conjunction with the accompanying drawings, in which:

FIG. 1 is a block diagram illustrating an apparatus for authoring a task in accordance with an embodiment of the present invention;

FIG. 2 is a flow chart illustrating a method for authoring the task—in accordance with the embodiment of the present invention; and

FIG. 3 is a view showing an example of overall behavior rule/procedure written in accordance with the embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

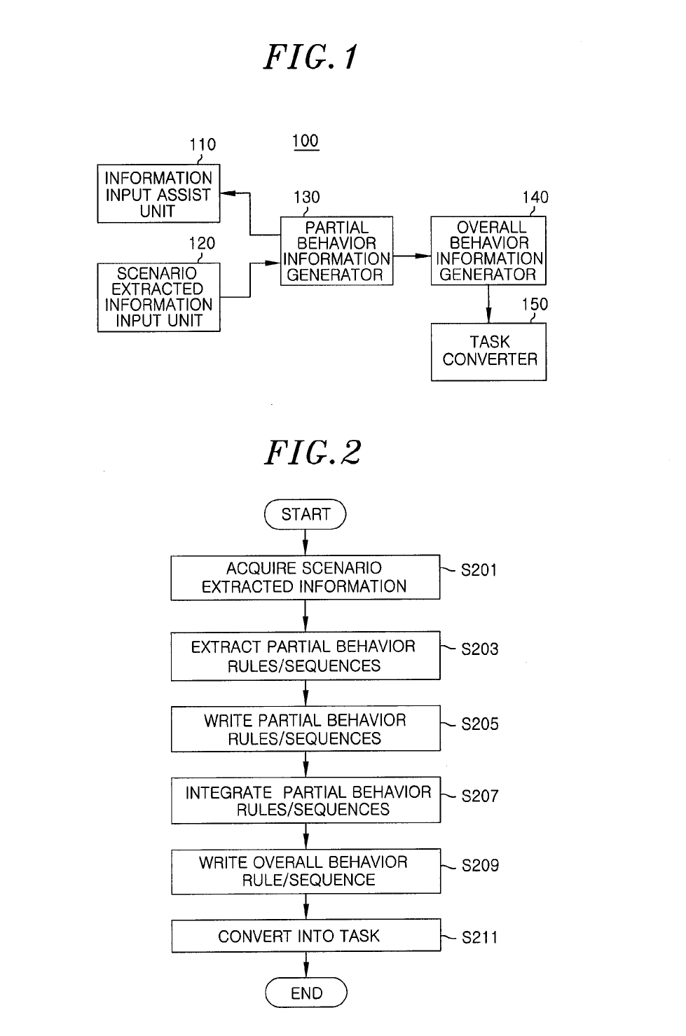

FIG. 1 is a block diagram illustrating an apparatus for authoring a task in accordance with an embodiment of the present invention.

As shown in FIG. 1, an apparatus 100 for authoring the task in accordance with the embodiment of the present invention may include an information input assist unit 110, a scenario extracted information input unit 120, a partial behavior information generator 130, an overall behavior information generator 140, and a task converter 150.

The information input assist unit 110 assists a user to extract basic information for authoring of a task, such as data, events, and behavior information, from a task scenario and to input the extracted basic information. For example, the information input assist unit 110 may guide how to select data, an event, and behavior information and to input the selected information.

The scenario extracted information input unit 120 is an interface allowing a user to extract and to input data, events, and behavior information as basic information for the authoring of a task from a task scenario. For example, the scenario extracted information input unit 120 allows a user to extract and to input data, events, and behavior information from the task scenario according to guide by the information input assist unit 110. A user who already knows how to extract and to input data, events, and behavior information may not be guided by the information input assist unit 110. Thus, the information input assist unit 110 may be excluded from the task-authoring apparatus 100.

The partial behavior information generator 130 extracts and writes partial behavior rule/sequence based on data, events, and behavior information which are inputted through the scenario extracted information input unit 120.

The overall behavior information generator 140 sets relationship between the partial behavior rule/sequence written by the partial behavior information generator 130 and integrates the partial behavior rule/sequence to write overall behavior rule/sequence according to the set relationship.

The task converter 150 converts the overall behavior rule/sequence written by the overall behavior information generator 140 into a task which a robot and/or an intelligent agent may execute.

FIG. 2 is a flow chart illustrating a method for authoring the task in accordance with the embodiment of the present invention.

As shown in FIG. 2, the method for authoring the task includes: acquiring data, events, and behavior information as basic information for authoring a task extracted from a task scenario in step S201, extracting and writing partial behavior rules/sequences based on the acquired data, events, and behavior information in steps S203 and S205, respectively, integrating the partial behavior rules/sequences according to a relationship therebetween in step S207, writing overall behavior rule/sequence in step S209 and converting the written overall behavior rule/sequence into a task that a robot and/or an intelligent agent may execute instep S211.

Although not shown in FIG. 2, the method for authoring the task may further include guiding and assisting a user to easily extract data, events, and behavior information from the task scenario and to input the extracted data, events, and behavior information before step S201.

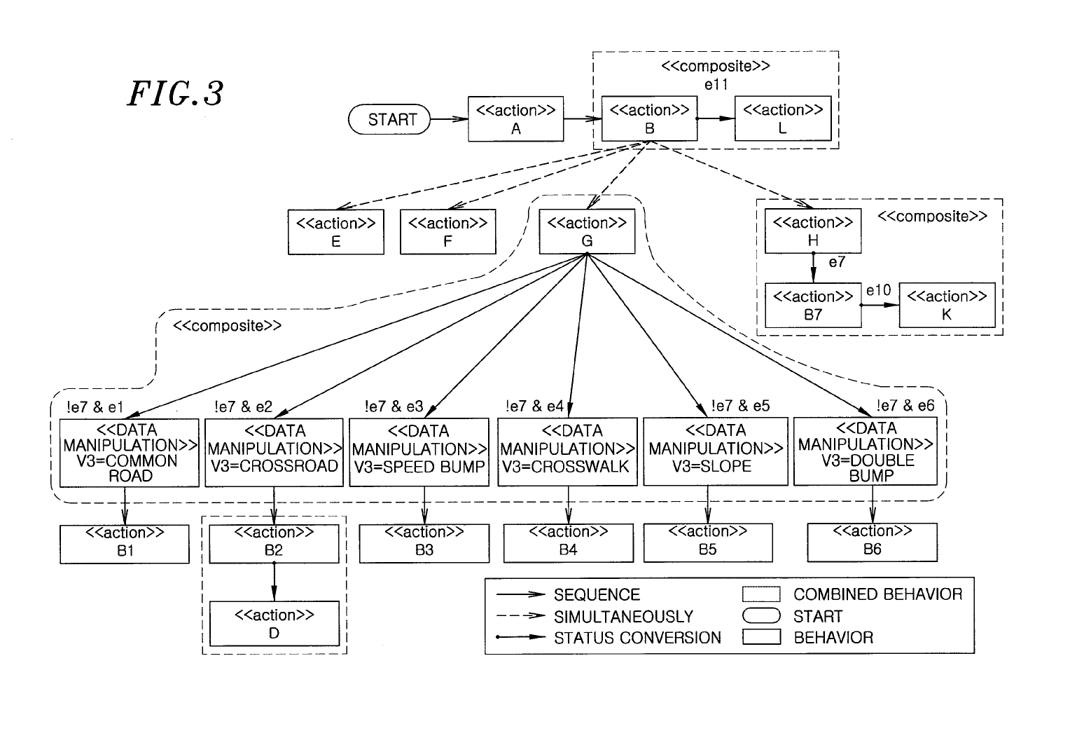

Hereinafter, a procedure of authoring the task carried out by the apparatus for authoring the task in accordance with the embodiment of the present invention will be described in time series with reference with FIGS. 1 to 3.

First, a user writes a task scenario in several sentences. There is none of constraints for the writing of a task scenario. However, the task scenario needs to include all of behavior rules and procedures of a task that a user wants without omission. The task scenario may be considered as user's demands for a task.

When the writing of a task scenario is finished, a user extracts data, events, and behavior information described in the task scenario. At this time, the information input assist unit 110 of the apparatus 100 for authoring the task may guide how to select data, events, and behavior information such that a user may extract data, event, and behavior information as basic information for authoring the task from the task scenario.

In this case, the data indicates information acquired from a robot and/or an intelligent agent while performing a task and a parameter stored in the robot and/or the intelligent agent. Events and behavior are situations that affect operations of a robot and/or an intelligent agent in the task scenario. In other words, events and behavior may be internal/external environmental changes of a robot and/or an intelligent agent or a user's command. Behaviors are operations of a robot and/or an intelligent agent extracted from in the task scenario in which the operations are described.

When data, events, and behavior information are extracted from the task scenario, a user inputs the extracted information through the scenario extracted information input unit 120 so that the scenario extracted information, that is, data, events, and behavior information are acquired by the apparatus 100 for authoring the task. In this case, the information input assist unit 110 of the apparatus 100 for authoring the task may guide how to input such that a user can input data, events, and behavior information as the basic information for authoring the task with the scenario extracted information input unit 120 in step S201.

Then, the partial behavior information generator 130 of the apparatus 100 for authoring the task extracts and writes the partial behavior rules/sequences based on the data, the events, and the behavior information which are inputted through the scenario extracted information input unit 120 in steps S203 and S205, respectively. The partial behavior rule/sequence are operation rule/sequence on a part that is described in the task scenario.

After that, the overall behavior information generator 140 sets relationship between the partial behavior rules/sequences written by the partial behavior information generator 130 in step S207 and integrates the partial behavior rules/sequences based on the set relationship to write overall behavior rules/sequences in step S209. These rules and sequences mean to rewrite ones described in syntactic structure of natural language in the task scenario according to preset behavior rules/sequence defining syntactic structure.

The following equation 1 shows an example in which syntax of the syntactic structure describing behavior rules and sequences of a robot and/or an intelligent agent using the data, the events and the behavior information described in Backus-Naur Form (BNF).

[Equation 1]

```
<task> ::= <behavior-seq>*
<behavior-seq>::= ”bs” ”:”<bsid>(<while>|<cwhile>|<do>|<cdo>
                              |<if>)
                    (<seq-while>|<seq-do>|<seq-if>)*”end-bs”
<while>::=”while””doing”<action><if>* ”end-while”
<cwhile>::”while” ”currently””doing”<action><cur-action>*
          <if>*”end-while”
<if>::”if”<conditional statements>””then”<do><else>?
<else>::=”else”<do>|<cdo>|<if>
<do>::=”do”<action> <seq-action>*
<cdo>::=”do””currently”<action> <cur-action>*
<cur-action>::=”and”<action>
<seq-action>::=”and then” <action>
<seq-do>::=”and then”<do>|<cdo>
<seq-while>::=”and then”<while>|<cwhile>
<seq-if>::=”and if”<if>
<action>::=<bsid>|<behavior of robot>|<manipulation of data>
```

Where +, *, ?, | represent once or more times, 0 (zero) time or more times, 0 time or once, and or, respectively.

In the BNF syntactic structure, a single task <task> has one or more behavior sequence <behavior-seq>. <behavior-seq> may have one of an involved execution <while>, simultaneously involved execution <cwhile>, execution <do>, simultaneous execution <cod>, or a conditional statement <if> and then <seq-while>, <seq-do>, and <seq-if> statements may be repeated. The involved execution <while> may have a condition <conditional statement> and may select a behavior to be executed against the condition. Behavior of a robot and/or an intelligent agent <action> may be an action of a robot, data manipulation, and behavior order.

Finally, the task converter 150 of the apparatus 100 for authoring the task converts the overall behavior rule/order written by the overall behavior information generator 140 into a task that a robot and/or an intelligent agent may execute in step S211.

Hereinafter, for more clear understanding of the task authoring method and apparatus of the present invention, an example using a virtual scenario of “driverless car travelling” running within a fixed space such as a park will be described.

First, a user writes a task scenario in several sentences as following example.

<Task Scenario for Driverless Car Travelling>

Environment in which a driverless car is driven is classified into zones according to their features such as a common road, a crossroad, a speed bump, a crosswalk, a slope, and a dual bump.

When a user designates a destination to a driverless car, a traveling route is created and the driverless car starts to travel. Simultaneously with the travelling, functions of recognizing lane and a passenger seat, grasping a zone (location), and detecting an obstacle start and keep going during the travelling.

During the travelling, the driverless car sets a steering angle and a vehicle velocity. The functions of recognizing a lane and a passenger seat are utilized for the setting of the steering angle and odometry is utilized at a crossroad. A preset vehicle velocity is utilize in a current zone for the setting of a vehicle velocity. However, when an obstacle is detected, a different vehicle velocity is determined according to a distance.
Sensor
A GPS receiver is utilized to determine a zone.
A camera is utilized to recognize a lane.
A laser sensor 1 is utilized to recognize a passenger seat.
A laser sensor 2 is utilized to recognize an obstacle.
An odometry is utilized to recognize a distance travelling from a crossroad.

In the above task scenario, a user extracts data, events, and behavior information. These information are extracted regardless of their order.

For example, data such as a vehicle velocity, a steering angle, and a current zone as listed in Table 1 may be extracted. According to depth of behavior's order that a user wants to describe, more data may be extracted. In this embodiment, only events, behaviors, and order of the behaviors of some description in the task scenario will be extracted using the above-mentioned three information.

TABLE 1

| ID | Type | Description |
|---|---|---|
| V1 | Float | Velocity |
| V2 | Float | Steering angle |
| V3 | Int | Current zone |

For example, events may be extracted as listed in Table 2. Events can be expressed by any conditional statement of a preset event like identifiers e8 and e9.

TABLE 2

| ID | Description |
|---|---|
| e1 | Current zone is a common road |
| e2 | Current zone is a crossroad |
| e3 | Current zone is a speed bump |
| e4 | Current zone is a crosswalk |
| e5 | Current zone is a slope |
| e6 | Current zone is a double bump |
| e7 | Recognition of obstacle |
| e8 | (e1 or e2 or e3 or e4 or e5) |
| e9 | Not e7 |
| e10 | Too close to obstacle |
| e11 | Arrival of destination |

For example, the behavior information may be extracted as listed in Table 3.

TABLE 3

| ID | Description |
|---|---|
| A | Create route |
| B | Travelling |
| B1 | Travel on common road |
| B2 | Travel at crossroad |
| B3 | Travel over speed bump |
| B4 | Travel across crosswalk |
| B5 | Travel on slope |
| B6 | Travel over double bump |
| B7 | Travel between obstacles |
| C | Acquire velocity at current |
| | zone and control velocity |
| D | DR travelling |
| E | Recognize lane |
| F | Recognize passenger seat |
| G | Grasp zone (location) |
| H | Detect obstacle |
| I | Drive odometry |
| J | Change current zone |
| K | Stop |
| L | Finish travelling |

When data, events, and behavior information in Tables 1 to 3 are inputted to the scenario extracted information input unit 120, the partial behavior information generator 130 writes partial behavior rule/sequence as listed in Table 4 according to syntax as listed in equation 1.

TABLE 4

| Behavior rule/sequence | Description |
|---|---|
| bs: 1 | A route is created and starts |
| do A and then do B | to travel. |
| while doing B | Functions of recognizing a |
| currently do E | lane and a passenger seat, |
| and F and G and H | grasping a zone, and |
| | detecting an obstacle are |
| | performed simultaneously |
| | during the travelling. |
| bs: 2 | Travelling is stopped at |
| while doing B | arrival to a destination |
| if e11 then do L | during the travelling. |
| bs: 3 | A vehicle is travelled in an |
| while doing H | obstacle travelling mode when |
| if e7 then do B7 | an obstacle is detected |
| | during the detection of an |
| | obstacle. |
| bs: 4 | When there is no obstacle |
| while doing G | during the grasping of zone |
| if not e7 and e1 then | and current zone is a common |
| do v3 = ‘common road’ | road, the current zone is |
| and then do B1 | changed into a common road |
| | and a vehicle is travelled in |
| | a common road travelling mode. |
| bs: 5 | When there is no obstacle |
| while doing G | during the grasping of zone |
| if not e7 and e2 then | and current zone is a |
| do v3 = ‘crossroad’ | crossroad, the current zone |
| and then do B2 | is changed into a crossroad |
| | and a vehicle is travelled in |
| | a crossroad travelling mode. |
| bs: 6 | When there is no obstacle |
| while doing G | during the grasping of zone |
| if not e7 and e3 then | and current zone is a speed |
| do v3 = ‘speed bump’ | bump, the current zone is |
| and then do B3 | changed into a speed bump and |
| end bs | a vehicle is travelled in a |
| | speed bump travelling mode. |
| bs: 7 | When there is no obstacle |
| while doing G | during the grasping of zone |
| if not e7 and e4 then | and current zone is a |
| do v3 = ‘crosswalk’ | crosswalk, the current zone |
| and then do B4 | is changed into a crosswalk |
| end bs | and a vehicle is travelled in |
| | a crosswalk travelling mode. |
| bs: 8 | When there is no obstacle |
| while doing G | during the grasping of zone |
| if not e7 and e5 then | and current zone is a slope, |
| do v3 = ‘slope’ | the current zone is changed |
| and then do B5 | into a slope and a vehicle is |
| end bs | travelled in a slope |
| | travelling mode. |
| bs: 9 | When there is no obstacle |
| while doing G | during the grasping of zone |
| if not e7 and e6 then | and current zone is a double |
| do v3 = ‘double bump’ | bump, the current zone is |
| and then do B6 | changed into a double bump |
| end bs | and a vehicle is travelled in |
| | a double bump travelling mode. |
| bs: 10 | When a vehicle travels at a |
| while doing B2 | crossroad, the vehicle is |
| do D | travelled in a DR travelling |
| | mode. |
| bs: 11 | During the travelling between |
| while doing B7 | obstacles, the vehicle is |
| if e10 then do K | stopped when the vehicle is |
| | too close to an obstacle. |

After that, the overall behavior information generator 140 sets relationship between the partial behavior rules/sequences to write overall behavior rules/sequences. Table 3 shows the overall behavior rules/sequences written from the partial behavior rules/sequences as listed in Table 4. As such, preset conversion rules are used to create the overall behavior rules/sequences.

First, “START” is created and is connected to behaviors defined in bsid 1.

Second, e1 is expressed as conditions for executing behavior A from an upper behavior B in pattern “While doing A if e1 then do B”, wherein A and B are in a status conversion relationship.

Third, A and B are in the status conversion relationship in “While doing A do B” pattern. A behavior without any condition means that “A” is converted into status B immediately when the status A starts.

Fourth, A and B are in a simultaneously executing relationship in “While doing A if e1 then currently do B and C” pattern, wherein A and C are also in a simultaneously executing relationship. Conditions in the two relationships are the same as e1.

Fifth, A and B are in simultaneously executing relationship in “While doing A currently do B and C” pattern, wherein A and C are also in simultaneously executing relationship. Conditions in the two relationships are the same as e1.

Sixth, behavior blocks connected by “And then” statement are in an sequential relationship.

Seventh, a starting point of status conversion to an end point may be combined into a single “Combined behavior.”

When the overall behavior information generator 140 writes the overall behavior rules/sequences using these conversion rules, the task conversion unit 150 converts the overall behavior rules/sequences into a task that a robot and/or an intelligent agent can execute.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for authoring a task, comprising:
a scenario extracted information input unit configured to receive data, an event, and behavior information that are extracted from a task scenario;
a partial behavior information generator configured to extract and write partial behavior rules/sequences based on the received data, event, and behavior information;
an overall behavior information generator configured to set relationship between the written partial behavior rules/sequences and integrate the partial behavior rules/sequences according to the set relationship to write overall behavior rules/sequences; and
a task conversion unit configured to convert the written overall behavior rules/sequences into a task which a robot and/or an intelligent agent may execute.

2. The apparatus of claim 1, further comprising an information input assist unit assisting to extract and input the data, the event, and the behavior information from the task scenario.

3. The apparatus of claim 1, wherein the overall behavior information generator converts the partial behavior rules/sequences using a preset conversion rule to write the overall behavior rules/sequences.

4. A method for authoring a task, comprising:
acquiring data, an event, and behavior information which are extracted from a task scenario;
extracting and writing partial behavior rules/sequences based on the acquired data, event, and behavior information;
integrating the partial behavior rules/sequences according to relationship between the written partial behavior rules/sequences to write overall behavior rules/sequences; and
converting the written overall behavior rules/sequences into a task that a robot or an intelligent agent executes.

5. The method of claim 4, further comprising assisting to extract and to input the data, the event, and the behavior information from the task scenario.

6. The method of claim 4, wherein said writing overall behavior rules/sequences is performed such that the partial behavior rules/sequences are converted using a preset conversion rule to write the overall behavior rules/sequences.
